(19) United States
(12) Patent Application Publication
(10) Pub. No.: US 2004/0159240 A1
(43) Pub. Date: Aug. 19, 2004

(54) Beverage brewing apparatus and method

(76) Inventor: Lucian H. Lyall III, Coto De Caza, CA (US)

Correspondence Address: Vern Schooley, Suite 1550, 200 Oceangate, Long Beach, CA, 90802, US

(21) Appl. No.: 10/366,740

(22) Filed: Feb. 14, 2003

(51) Int. Cl. A23L 1/00

(52) U.S. Cl. 99/275

(57) ABSTRACT

A brewing apparatus having a temperature sensor disposed on a warming deck that receives a brewed beverage decanter provides temperature information used to select a heating profile for maintaining the brewed beverage at a proper serving temperature without overheating. An intermittent heating profile based on the temperature difference between the actual brewed beverage temperature and the desired temperature is recalled from memory storage and applied to a heating element below the warming deck.

### BACKGROUND OF THE INVENTION

The present invention is related generally to a beverage brewing apparatus and method, and more particularly to a brewing apparatus having a programmable heating function with feedback for warming the brewed beverage without overheating.

Coffee brewing apparatuses are plentiful in the art and come in many shapes and sizes. Most coffee brewing apparatuses include four or five basic elements: a filter basket for holding a filter or filter packet of coffee grounds; a channel for directing heated water from a stored reservoir to the filter basket; a decanter or vessel for collecting the brewed coffee that flows through the filter basket; and in many cases a heating element in combination with a warming deck for maintaining the brewed coffee at an elevated temperature prior to serving.

A warming deck is typically a flat plate upon which the decanter rests during the brewing operation, where the flat plate may be heated from below by a resistive heating element. The heating element may be triggered by the initiation of the brewing operation, the presence of the decanter, by a controller, or other function. The heating element may remain activated for a predetermined time before an automatic shut-off occurs, or the heating element may remain on after the brew cycle until it is manually shut off for situations where the coffee sits for long periods of time or where the coffee is constantly refilled, such as restaurants and the like.

Coffee is best when served at elevated temperatures and the heating element allows brewed coffee to be maintained at a serving temperature until it's ready to serve. The need to maintain brewed coffee at a relatively high serving temperature (typically between 175° F. and 195° F.) requires that the actual heating element be heated to an even higher temperature due to losses to the surrounding warming deck and decanter. The problem with extended exposure of the decanter to an elevated heating element is that localized micro-boiling of the beverage can occur near the heating element. Micro-boiling is the creation of miniature gas bubbles within the decanter immediately adjacent the heating element. This micro-boiling, which is not to be confused with a turbulent boiling of the bulk liquid, is not always obvious but can degrade the flavor of coffee and other beverages by introducing oxygen into the coffee leading to oxidation. Oxidation negatively impacts the flavor of coffee by causing a bitter taste, and accordingly oxidation is to be avoided if possible. The problem that the present invention addresses is how to warm the coffee or other beverages to temperatures close to the actual boiling temperature of the beverage without causing localized micro-boiling at the surface where the decanter is adjacent the heating element.

To prevent micro-boiling, it is known to use low energy heating elements that do not heat above the coffee's desired warming temperature. Using a low energy heating element allows the warming function to remain actuated for long periods of time since the heating element cannot raise the temperature above the critical micro-boiling temperature. However, using low capacity heating elements has its disadvantages in that heating times are increased and response time is much longer to warm coffee.

Adding to the problem of controlling the heating process is the presence of outside factors that affect the temperature of the coffee and the heating process. The ambient temperature of a coffee maker can vary dramatically depending on where it is located. That is, a coffee maker located in the kitchen of a busy restaurant may experience an excessively warm environment that contributes to the heating process, whereas a coffee maker located near the door of a coffee bar or the lobby of a ski lodge may be significantly cooled by the surrounding environment hindering the warming process. A coffee brewing apparatus that employs a constant heating step in each of these three examples would produce distinctly different heating outcomes, leading to unsatisfactory heating and/or unnecessary micro-boiling of the warmed beverage. Other factors can influence the heating process, such as elevation, the heat transfer of the warming deck and decanter, and the frequency of the brewing cycles because a cold warming deck used for the first time that day will behave differently than a warming deck that has already been heated from a previous cycle. The unpredictability of the conditions poses yet more problems when attempting to predetermine a warming function with the goal of avoiding micro-boiling.

To protect against micro-boiling while maintaining the coffee at acceptable standby temperatures, some brewing apparatuses place a thermally protective blanket at the bottom of the satellite decanter adjacent the heating element to diffuse the heat in an attempt to avoid localized ultra-heating at the contact point adjacent the heating element. The protective blanket can reduce the presence of localized hot spots and is generally effective against micro-boiling up to certain temperatures. However, the protective blanket cannot be exposed to moisture which makes sanitizing the decanter by submersion in heated water impossible. As a result, other more costly and time-consuming methods are required to clean the satellite decanter. Thus, for many applications the use of a protective blanket is unsatisfactory and the art is in need of a brewing apparatus that can maintain brewed coffee and other beverages at their desired serving temperature for extended periods without overheating the liquid.

### SUMMARY OF THE INVENTION

The present invention comprises a beverage brewing apparatus that includes a heating element controlled by a microcontroller that first determines the heating condition of the brewed beverage in a decanter or reservoir, and controls the heating element to apply a periodic or intermittent heating profile to prevent micro-boiling of the beverage. In a first preferred embodiment a thermistor or temperature sensor is mounted to the warming deck for measuring a temperature response of the warming deck and, inferentially, the decanter on top of the warming deck. A temperature is measured by the temperature sensor and stored in the memory of a microprocessor in communication with the temperature sensor. The stored temperature is used to select a heating profile from among a set of stored heating profiles located in the micro controller's memory storage.

In a first preferred embodiment, when the microcontroller determines that the coffee to be warmed is several degrees below the desired temperature the microcontroller preferably applies a first heating profile corresponding to full or substantially constant power. As the temperature approaches the desired temperature, the heating element is systematically shut off and turned on intermittently for predetermined durations depending on the proximity of the measured temperature to the desired temperature. Once the desired temperature is reached, the heating element is turned off to prevent overheating and boiling, and the feedback system works to maintain the beverage at the proper temperature without overheating. In this manner, the beverage is prevented from micro-boiling due to overheating. Thus, in a first preferred approach the temperature profile is determined by the temperature of the beverage in relation to a desired temperature of the beverage. Alternatively, the intensity of the heating element can be varied rather than the duration such that a high intensity is applied when the measured temperature is well below the desired temperature, and a moderate to low intensity is applied as the measured temperature approaches the desired temperature.

In another preferred embodiment, a temperature measurement is first performed and then the heating element is actuated for a predetermined time period after which a second temperature measurement is collected. The temperature rise in the warming deck can be used to measure the heating capacity of the beverage in the decanter, which is a function of the quantity of the beverage being heated, the losses due to environmental factors, and other influences. The microcontroller uses a lookup table or performs a calculation to estimate the quantity of beverage based on the heating response measured by the temperature sensor. For a given estimated quantity of beverage, a periodic heating profile experimentally determined to prevent micro-boiling is recalled by the microcontroller's memory and applied at the heating element. The monitoring of the beverage quantity ensures that a heating profile suited for a full decanter is not applied to a mostly empty decanter leading to micro-boiling.

Alternatively, the decay in temperature of the warming deck from a given heated temperature can also be used to determine the quantity of beverage. The decay in the temperature of the warming deck will be proportional to the amount of liquid being heated where the proportionality is related to the specific heat coefficient of the liquid. Other environmental factors will affect the temperature drop, such as ambient temperature, the temperature of the brewing apparatus, and heat loss through the satellite decanter, and these factors are accounted for in the feedback loop.

By determining the heating characteristics of the brewing environment, a selected heating profile from among a set of stored profiles can be recalled and applied to the warming deck that is experimentally or theoretically predetermined to avoid micro-boiling for the given condition. The temperature response of the warming deck is constantly monitored and a new heating profile is recalled as the conditions change, such as when the decanter is emptied or filled.

To evaluate the response of the beverage in the decanter, it is preferred that the thermistor or temperature sensor be located in a position to provide the most accurate gauge of the temperature of the beverage without undue influence from the actual heating element. To allow the decanter to be immersible in water, it is preferred that the temperature sensor not be located on the decanter itself and that no insulating blanket or other water-incompatible components be included on the decanter. This allows the decanter to be completely immersed in water and enables conventional cleaning, such as in a dishwashing machine or simply immersed in hot water. Since the sensor is not located on the decanter, its placement on the warming deck is important to accurately evaluate the temperature of the decanter and thus the beverage in the decanter. If the sensor is too close to the heating element it may improperly be influenced by the heat radiating directly from the heating element instead of the heat conducted by the beverage in the decanter. But if the sensor is not immediately adjacent the decanter it will not accurately estimate the temperature of the beverage. The present inventor has discovered that an optimum location for the thermal sensor is adjacent the neck of a D-shaped resistive heating element between a pair of non-heating arms. This location permits a preferred response between the temperature of the beverage in the stainless steel satellite decanter and the temperature of the warming deck at the sensor.

In one preferred embodiment the heating element comprises a tubular member with a substantially circular cross-section and a flattened contact surface to increase the surface area contact between the heating element and the warming deck to improve heat transfer to the warming deck and provide a more efficient heating response. In another preferred embodiment, the heating element is a high capacity heating element such as a one hundred fifty watt heating element to more rapidly bring the beverage to the optimum temperature. Because of the feedback response, the present invention allows the use of higher capacity heating elements leading to better control of the brewed beverage temperature since control of the temperature sensor is greatly improved. This overcomes the disadvantage of the prior art in requiring a low capacity heating element to avoid micro-boiling.

These and other features and advantages of the present invention will become apparent from the following detailed description of a preferred embodiment which, taken in conjunction with the accompanying drawings, illustrates by way of example the principles of the invention.

### BRIEF DESCRIPTION OF THE DRAWINGS

FIG. 1 is a front view of a coffee brewing apparatus, partially cut away to illustrate the warming deck and heating elements of the present invention;

FIG. 2 is a view along lines 2-2 of FIG. 1 showing the underside of the warming deck of the brewing apparatus of FIG. 1;

FIG. 3 is an enlarged plan view of the heating element of FIG. 1 further illustrating a preferred sensor location of the brewing apparatus of FIG. 1;

FIG. 4 is a cross-sectional view of the heating element along lines 4-4 of FIG. 3;

FIG. 5 is a schematic diagram of the control system of the brewing apparatus of FIG. 1; and

FIG. 6 is an example of a heating profile of the control system of the brewing apparatus of FIG. 1.

### DETAILED DESCRIPTION OF THE PREFERRED EMBODIMENTS

The brewing apparatus of the present invention applies a sequence of heating pulses via a resistive element to a warming deck of a brewing apparatus in order to maintain a brewed beverage at a relatively high serving temperature without adversely affecting the taste of the beverage. The sequence of heating pulses is determined by applying a profile from among a set of stored heating profiles based upon an evaluation of the heating requirements. The heating requirements may be governed by the amount of beverage to be warmed or by the proximity of the actual temperature to the desired temperature. In the case of the former, if the decanter holding the beverage to be warmed is full, a heating profile is selected that will apply heat more frequently and/or in longer durations that if the decanter is half full or nearly empty. Also, if the ambient temperature is colder or if there is unusual heat loss of the decanter, a profile is applied that maintains the beverage at the serving temperature without applying excess heat that could cause localized boiling of the beverage. In the case of the latter, as the beverage approaches the desired maximum temperature the heating pulses occur with less frequency to prevent the temperature from overshooting the desired maximum temperature, which can lead to micro-boiling. In either case, using the proper heating profile based upon a temperature feedback reduces the likelihood that the beverage will be overheated and boil, which in turn introduces oxygen bubbles into the beverage that are absorbed into the liquid causing a bitter taste.

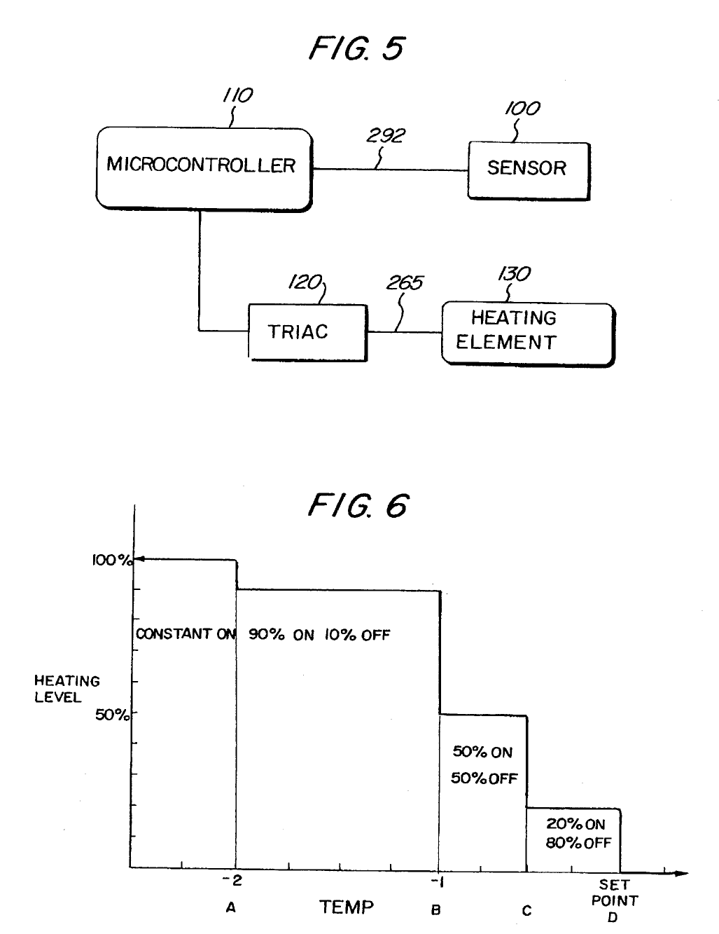

FIG. 5 illustrates a schematic of the feedback system used to control the temperature of the beverage reservoir. A temperature sensor 100 located in the vicinity of the warming deck as described more fully below measures the temperature of the warming deck immediately below the decanter holding the brewed coffee. The decanters are traditionally comprised of a metal such as stainless steel or aluminum that readily conducts the heat between the metal warming deck and the coffee's bulk temperature fairly rapidly. The temperature sensor 100 is in communication with a microprocessor or microcontroller 110 that processes the signals received from the temperature sensor 100 and converts the signals to a digital representation of the observed temperature. The microcontroller 110 also sends a signal to a triac 120 or voltage regulating apparatus that opens and closes an electrical circuit to energize a resistive heating element 130. The resistive heating element radiates heat as a result of receiving the voltage response from the triac 120 which in turn is used to heat the warming deck and the decanter used to hold the brewed coffee.

FIG. 1 shows a bottom portion of a coffee brewing apparatus 150 comprising two removable square satellite decanters 140 seated on a warming deck 160. Each satellite decanter includes a spout 170 for dispensing the brewed coffee therein and a level indicator 180 for determining the quantity of coffee inside the decanter. Positioned above each decanter is a coffee filter basket 190 as is known in the art. The position of the filter basket is such that an opening at the bottom of the filter basket is immediately above an opening in a lid 192 of the decanter 190 such that infused liquid entering the filter basket will contact dry coffee granules and remove flavored solutes from the granules. The liquid with the removed flavor solutes pass through a filter in the filter basket to prevent the introduction of the granules into the beverage and then pours though the opening in the lid 192 of the decanter and collects in the decanter 190.

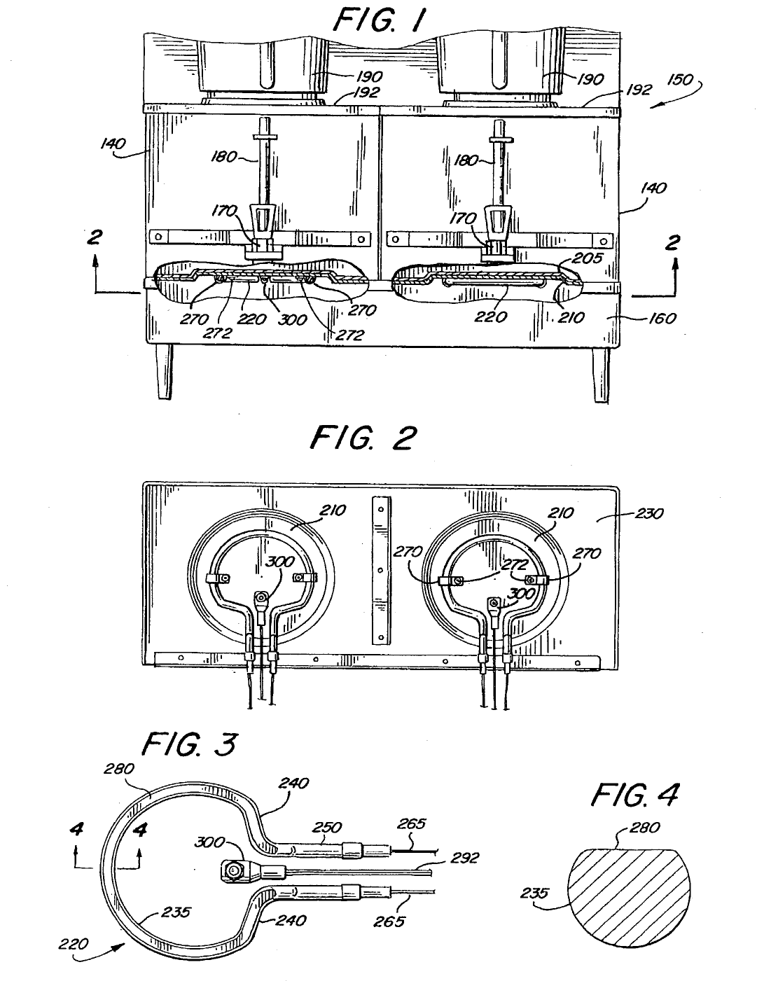

The bottom of the satellite decanter is preferably formed with a frusto-conical recess 205 coinciding with a corresponding boss 210 onthe upper surface of the warming deck 160. The mating recess and boss serve to align the decanter on the warming deck. As shown in FIGS. 1 and 2, the raised frusto-conical boss 210 of the warming deck 160 defines a cavity beneath the warming deck 160 corresponding to the location of a tubular heating element 220. FIG. 2 shows the underside 230 of the warming deck 160 where the heating elements 220 for each decanter 140 are mounted. The heating elements 220 shown in detail in FIGS. 3 and 4 are comprised of a semi-circular tubular member forming a heatable portion 235 terminating at each end to form a non-heatable converging segments 240. The two non-heatable segments 240 merge toward on another into a parallel configuration to form a neck 250 of the heating element. The neck 250 transitions out of a plane defined by the semi-circular heatable portion 235 due to the different elevations inside the boss 210 and outside the boss. That is, if the semi-circular heatable portion of the heating element shown in FIG. 3 is in the plane of the page, the neck 250 is raised slightly above the page to accommodate the transition of the heating element into the cavity of the boss 210. As configured, the heating element only radiates heat along the semi-circular portion 235 while the converging segments 240 and the neck 250 preferably do not conduct or radiate heat when the heating element is actuated. Cables 265 are used to deliver current to the resistive element 220 are connected to the microcontroller 110 via the triac 120. When the microcontroller initiates a heating profile it simply controls the triac to open the electrical circuit and delivers an electrical current to the resistive element for a given period, allowing the resistive element to heat up and raise the temperature of the warming deck and, by conduction, the decanter thereon.

Each heating element 220 is mounted to the bottom of the warming deck 160 by a pair of brackets 270 secured by a fastener 272. The heating element also is shaped to have a substantially circular cross-section with a flattered upper surface 280 along the semicircular heatable portion 235 of the heating element 220. The flattened upper surface 280 of the heating element is positioned flush against the lower surface 230 of the warming deck at the boss 210 to increase the surface area contact between the heating element and the warming deck. The increased contact provides a more rapid response to the heating element and improves the heat conduction between the heating element and the warming deck.

The warming deck 160 also includes a thermal sensor 300 mounted thereon for measuring the temperature of the warming deck immediately below the satellite decanters. Located on the underside of the warming deck with the heating element, the sensor 300 is physically separate from the decanter 140 freeing the decanter from any electrical connections that would preclude its submersion in water. Thus, the separation of the thermal sensor from the decanter allows the decanter to be sanitized by conventional means. Separating the sensor from the decanter requires that the sensor placement be carefully chosen so as not to impair the apparatus' ability to accurately measure the temperature of the decanter and thus the beverage inside. The present inventor has determined that by placing the sensor in a specific location as generally shown in FIG. 3 the estimation of the brewed beverage in the decanter 140 is very good. Here, the temperature sensor 300 is located equal distance between the two non-heatable arms or segments 240 of the heating element 220 within the interior of the heating elements' arc. Radiating heat from the semi-circular heatable portion 235 is minimized and the temperature reading of the sensor 300 is very approximately the temperature of the decanter 140 on the warming deck 160 due to the high thermal capacity of water. That is, the thermal capacity of water, of which beverages such as coffee are essentially comprised, is such that the temperature of the stainless steel warming deck will very closely approximate the temperature of the beverage in the decanter. The sensor 300 includes a cable 292 that communicates the electrical signals generated by the sensor to the microcontroller 110 where the signals are processed and converted into digital signals.

By measuring the actual temperature of the beverage and comparing the actual temperature to the temperature of the warming deck 160 at the sensor 300, a correlation between the two temperatures can be established and stored in the memory of the microcontroller 110 for future calculations. The microprocessor 110 may also include a clocking means for measuring time from the initiation of a heating cycle to its termination. By polling the sensor 300 at timed intervals, a temperature decay profile can be established as the temperature of the decanter drops from its initial value. The slope of the temperature versus time curve provides the controller with information used to determine the condition of the satellite decanter and the amount of heat being dissipated to the environment, which is a function of beverage quantity, ambient temperature, and other environmental factors. For example, a full satellite decanter will lose heat more slowly than a nearly empty decanter, and the slope of the temperature versus time curve will be shallower for the former than the latter. For a particular slope range, a heating profile is obtained by the microcontroller from a stored set of heating profiles that have been shown experimentally to avoid micro-boiling while maintaining the beverage at the desired temperature.

FIG. 6 illustrates an embodiment of a heating profile stored in the memory of the microcontroller and applied to the warming deck to heat the beverage in the decanter. The heating profile is shown with an actuation percentage on the vertical axis and the temperature of the beverage in the decanter in the horizontal axis. By using the temperature sensor 300 to measure the temperature of the warming deck 160 and then using stored conversions for converting the warming deck temperature to the beverage in the metal decanter on the warming deck, the microcontroller can readily determine what the present position on the horizontal axis corresponds to a given measurement. For example, if the beverage temperature is measured to be two degrees or more below the optimum temperature, the microcontroller judges the current position on the horizontal axis to be to the left of the point A. The microcontroller then implements a full or constant heating profile meaning that the current delivered to the heating element is constant as long as the condition of the beverage temperature is to the left of point A on the graph. Once the temperature increases to a level between points A and B corresponding to a condition between two and one degree below desired temperature, an intermittent heating profile is initiated. This is graphically shown in FIG. 6 as a ninety percent profile corresponding to a ninety percent on and ten percent off intermittent condition (e.g., 2.7 seconds actuated and 0.3 seconds off). As the beverage continues to heat until the temperature reaches a condition between points B and C, the intermittent heating profile switches to fifty percent, or half on and half off (e.g., 1.5 seconds on and 1.5 seconds off). When the temperature reaches within one half degree of the set point corresponding to the position between C and D, the intermittent profile reduces to twenty percent on and eighty percent off (e.g., 0.6 seconds on and 2.4 seconds off). Finally, should a temperature corresponding to the set point temperature (point D) or above, the heating ceases until a condition to the left of point D occurs.

By controlling the heating profile according to the temperature of the beverage, overheating the beverage can be substantially avoided. The heating profiles described above are illustrative and are meant only as an example, as other profiles may similarly control the temperature of the beverage. An alternative embodiment provides for a heating profile variable in heating intensity rather than duration. For example, if the vertical axis on the chart of FIG. 6 is replaced with heating intensity, the highest intensity is applied to the left of point A and incrementally decreasing intensity is applied as the desired temperature is approached. The systematic control of the heating process can be improved with a high capacity heating element such as a one hundred fifty watt heating element. A high capacity heating element is undesirable in the prior art systems without the aforementioned heating controls because prolonged actuation of the high capacity heating element creates a very high likelihood of micro-boiling. However, the approach of the present invention controls the heating element based on the temperature of the beverage allowing the use of the high capacity heating element, resulting in faster heat times and quicker response to warming functions.

To further refine the heating process, a constant heating cycle can be applied to the warming deck to measure the amount of temperature increase of the beverage in the satellite decanter. The rise in temperature provides information on the heating capacity of the contents of the decanter, such as quantity of beverage and thermal loss due to environmental factors. By determining the conditions for heating the beverage, an appropriate heating profile can be selected from a list of profiles stored in the memory of the microcontroller based on empirical data or heat transfer calculations stored within the memory of the microcontroller. In this manner, careful control of the heating of the beverage can prevent overheating and preserve the integrity of the beverage without oxidation.

While a particular form of the invention has been illustrated and described, it will also be apparent to those skilled in the art that various modifications can be made without departing from the spirit and scope of the invention. Accordingly, it is not intended that the invention be limited except by the appended claims.

What is claimed is:

1. A brewing apparatus comprising:
a warming deck for supporting a decanter thereon;
a heating element below the warming deck for radiating heat to the warming deck;
a temperature sensor in contact with the warming deck for generating temperature signals corresponding to a measured temperature of the warming deck; and
a microcontroller in communication with the temperature sensor for receiving the temperature signals from the sensor, and for actuating the heating element in response to the received temperature signals.

2. The brewing apparatus of claim 1 wherein the microcontroller selects a heating profile from among a set of stored heating profiles based upon the temperature signals received, and actuates the heating element according to the selected heating profile.

3. The brewing apparatus of claim 2 wherein the heating profile is selected based upon a temperature difference between a measured temperature at the sensor and a preselected temperature determined from a beverage optimum serving temperature.

4. The brewing apparatus of claim 3 wherein the heating profile comprises actuation periods of a varying duration depending upon the difference between the measured temperature and the preselected temperature.

5. The brewing apparatus of claim 4 wherein the heating profile comprises a first stage of a constant actuation, a second stage of ninety percent actuation, a third stage of fifty percent actuation, and a fourth stage of twenty percent actuation.

6. The brewing apparatus of claim 3 wherein the heating profile comprises intensity variations of the heating element depending upon the difference between the measured temperature and the preselected temperature.

7. The brewing apparatus of claim 1 wherein the heating element comprises a tubular semicircular member having first and second ends terminating in non-heating converging segments cooperating at distal ends in a parallel configuration to form a neck portion, where the temperature sensor is located adjacent the neck portion equal distant from the non-heating converging segments.

8. The brewing apparatus of claim 1 wherein the heating element comprises a tubular member of substantially circular cross-section having a flattened upper surface mating with the warming deck.

9. An improved brewing apparatus comprising a brew basket, a reservoir for storing a supply of heated infusion liquid, and a decanter for collecting a brewed beverage, comprising:
a warming deck for supporting the decanter thereon and for conducting heat to the decanter;
a resistive heating element in contact with an underside surface of the warming deck for heating the warming deck;
a temperature sensor in contact with the underside surface of the warming deck for measuring a temperature of the warming deck below the decanter and generating a temperature signal corresponding to the measured temperature of the warming deck, where the measured temperature is dependent upon the temperature of the decanter; and
a microcontroller in communication with the temperature sensor for receiving the temperature signals from the sensor, and for controlling the heating element intermittently in response to the received temperature signals.

10. The brewing apparatus of claim 9 wherein the microcontroller collects successive temperature measurements from the temperature sensor to determine the behavior of a system to be heated corresponding to a decanter condition, and then recalls from a memory a heating profile corresponding to the determined condition.

11. The brewing apparatus of claim 10 wherein the behavior of the system is the decay in temperature of the warming deck for a predetermined unheated time interval.

12. The brewing apparatus of claim 10 wherein the behavior of the system is the rise in temperature of the warming deck after a predetermined heated time interval.
